(19) United States
(12) Patent Application Publication
(10) Pub. No.: US 2009/0160764 A1
(43) Pub. Date: Jun. 25, 2009

(54) Remote Control System

(76) Inventor: Matti Myllymäki, Helsinki (FI)

Correspondence Address: DRINKER BIDDLE & REATH (DC), 1500 K STREET, N.W., SUITE 1100, WASHINGTON, DC, 20005-1209, US

(21) Appl. No.: 12/085,519

(22) PCT Filed: Nov. 21, 2006
(86) PCT No.: PCT/FI2006/050505

§ 371 Date: Dec. 18, 2008

(30) Foreign Application Priority Data
Nov. 28, 2005 (FI) 20051211

(51) Int. Cl. G06F 3/03

(52) U.S. Cl. 345/156

(57) ABSTRACT

A remote control system, comprising a hand-operated remote control device and a control menu present in a display unit. Picking up the remote control device by hand activates a motion or position or push-button controlled user interface in the display unit. The remote control device is provided with an identification feature for its pick-up by hand, which activates the control menu and/or the remote control device. The motional and/or positional handling of the remote control device enables controlling the display unit's menus included in the user interface.

A system for implementing a remote controller operating on a motion or position or push-button operated user interface, such that picking it up by hand activates automatically a display unit and a menu.

### PRIOR ART

Today's households have typically 4-6 remote controllers for operating entertainment equipment. In addition to this, smart homes have often specific remote controllers for operating domestic lighting and air conditioning, as well as a remote controller, a separate keyboard and a mouse for operating a multimedia PC.

A problem with currently available solutions is the large number of remote controllers and the diversity of user interfaces, as well as latency times in the remote control of a multimedia PC. Using these in darkness or dim light is also difficult, let alone persons whose motoric abilities are inadequate for pressing small buttons. Attempts have been made to solve the problem with remote controllers which enable operating several pieces of equipment. These can only be substituted for those used in the field of entertainment equipment, but attempting to use those e.g. to replace the keyboard of a multimedia PC is not feasible. Motion-controlled mouses are also available, but because of the high power consumption thereof, must be kept in a charging device whenever not in active service. Another thing called for by the motion-controlled mouse is a PC-based permanently switched-on menu, which is not highly suitable for entertainment equipment.

For example, the operation of a home theater requires simultaneous use of several pieces of entertainment equipment, whereby the user must know how to use program options for linking correct pieces of equipment to each other. This calls for a good familiarity with the equipment and giving several remote control commands, which may prove too much for many a basic user.

Commercially available are also intelligent touch-screen remote controllers which enable transmitting control command strings and thereby controlling individual appliances, the use thereof requires familiarity with a major apparatus which is not comparable with traditional remote controllers. In the activation process of e.g. home theaters, the remote controller must be held pointed at various pieces of entertainment equipment for the duration of an entire string of control commands.

It is an object of the invention to create a novel control system provided with a highly simple user interface, which enables resolving the foregoing problems and using just one control device to operate all appliances at home, as well as using it also for text input.

This object is accomplished on the basis of the characterizing features set forth in the appended claims.

What is novel about the system is that the remote controller need not be provided at all with traditional control buttons and the actual user interface and the control menu have been included in a display unit, which can be a TV or PC screen. In order to minimize power consumption, the remote control device senses being picked up by hand and activates the display unit's menu and its own high-power electronics only for the duration of a control procedure. Thus, the remote controller need not be kept all the time in a charging device and the menu can be set up appropriately for entertainment equipment and, if necessary, customized as desired. By virtue of the fact that the menu has been transferred onto a display unit, all appliances to be controlled are visible as individual separate main or submenus, whereby an indefinite number of such menus can be attached, all with a similar user interface. A position of the control device also enables direct activation of a desired menu and desired pieces of equipment, thereby avoiding the transmission of several sequential remote control commands. The control device can also be used in total darkness, being void of traditional control buttons. It is also very useful for visually impaired, motorically restricted, as well as handicapped persons by virtue of a large display and modifiable motion control.

By virtue of the system, the control of all entertainment equipment can be conducted in a manner much simpler and more convenient for the user than before. This is possible because the remote controller does not transmit actual infrared commands to various appliances, but merely controls a menu, after the activation of which the commands for various appliances are transmitted by a separate controller or by the integrated software and infrared emitters of a TV, PC or digibox. Accordingly, the user is not required to hold the remote controller still and pointed at entertainment equipment during command strings.

The invention will now be described in more detail with reference to the accompanying drawings, in which:

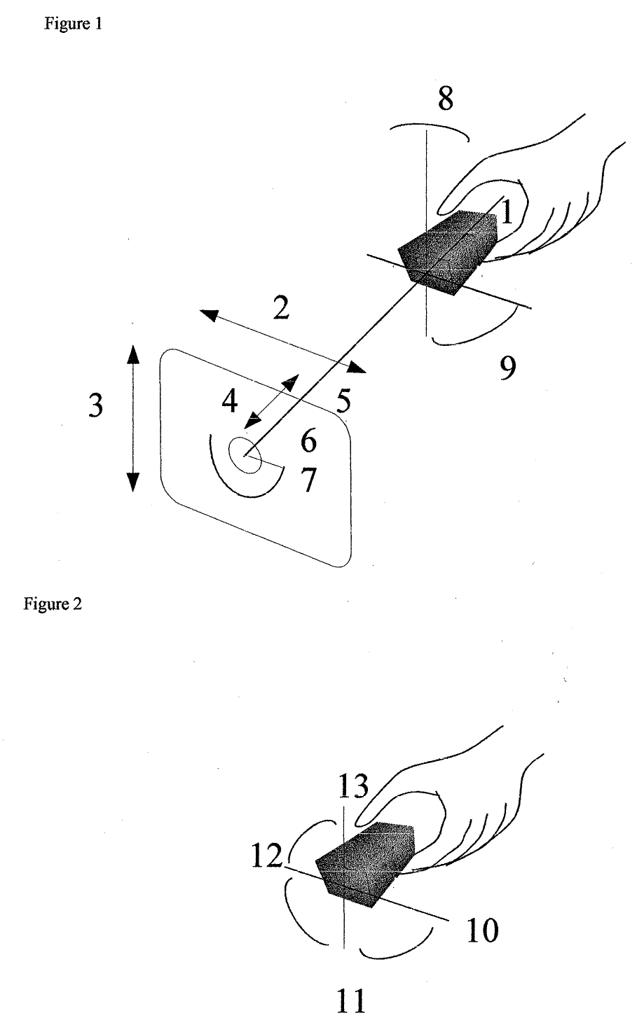

FIG. 1 shows a system of the invention in terms of its operating principle,

FIG. 2 shows a position-controlled menu drive based on a system of the invention,

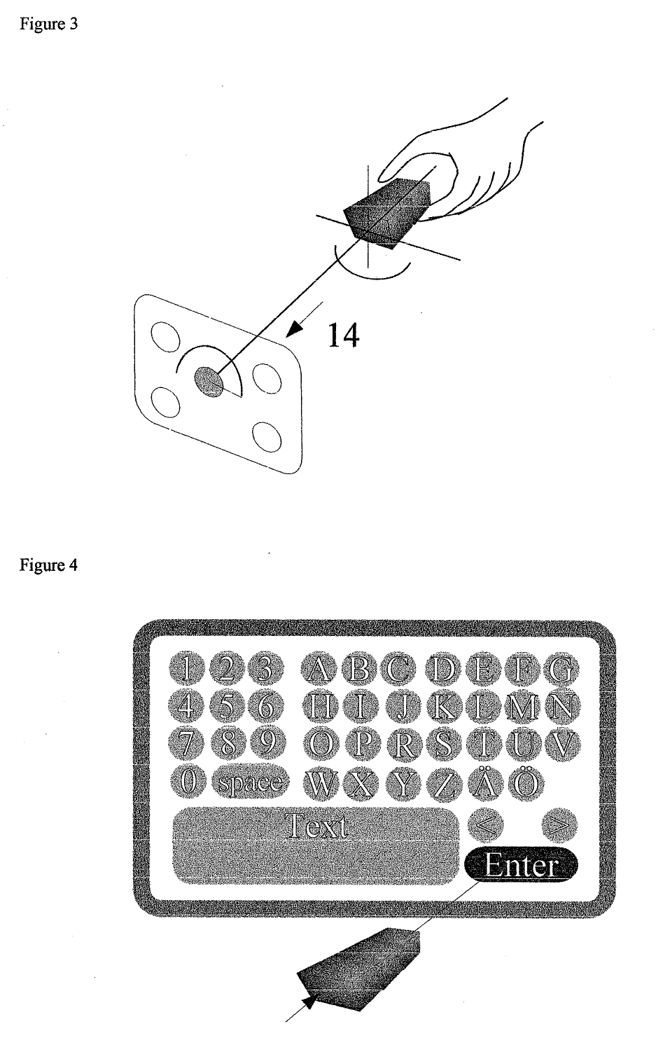

FIG. 3 shows an activation procedure based on a system of the invention for a control button or an analog tuner, and

FIG. 4 shows a control device application based on a system of the invention for text input.

FIG. 1. The operating principle in a system of the invention is based on a remote controller (1), which in its best configuration is completely void of moving parts or keys, as well as on a display unit (5), in which is integrated necessary software as well as infrared emitters and other signaling means for controlling other appliances. The display unit may comprise the screen of a TV or PC and the controlling device may comprise a TV, PC, digibox or a separate controller assigned to this service. Picking up the remote controller by hand is identified by prior known methods, for example by means of a capacitive detector. Upon identifying a pick-up by hand, the remote controller immediately transmits a message wirelessly over either an infrared or radio-frequency communication link to the display/control unit (5) which opens up a user interface (6) on the screen. The remote controller (1) is provided with a conventionally engineered 3-way accelerometer and relevant electronics capable of identifying even the slightest movements and transmitting the same to the display unit (5). In keeping with motion control, a cursor visible on the screen shifts in a lateral (2) and vertical sense (3) as well as by rotation in the direction of its axis clockwise and counter-clockwise (8, 9). A depthwise (4) motion is also identified and used for activating a desired control symbol (7), which can thus be controlled the same way as by using a tuner or a button from at touching distance. As soon as the remote controller (1) comes to a standstill or it is laid down, the menu disappears from the display unit.

FIG. 2. Shows a menu control based on a system of the invention and driven by an axial position, which is based on providing each side (10, 11, 12, 13) of the remote controller with a symbol, the menu corresponding thereto popping up on the display screen. If, for example, the side (10) carries a TV symbol, turning that side up brings a TV menu on the display unit and activates relevant equipment. If the opposite side (12) carries a radio symbol and that side is turned up, the display unit will show a radio menu and desired equipment is activated. Hence, a person using the remote controller is able to proceed from one menu to another simply by turning a desired symbol to face upwards.

FIG. 3. Shows an activation procedure based on a system of the invention for a control button or an analog tuner, according to which a desired symbol is activated by pushing (14) the remote controller forward. The operation of an analog tuner proceeds also by first pushing (14) the remote controller forward, followed by rotating the same either clockwise or counter-clockwise, whereby the tuner rotates consistently with the movement. Once the tuning has been made, the remote controller is pulled (12) backwards for releasing the symbol. If desired, the remote controller can also be provided with a control button for activating a symbol pointed by the cursor.

FIG. 4. Shows a control device application based on a system of the invention for text input. The input of text is effected by moving a cursor on the screen at a desired alphabetic character or function key. The cursor is in coincidence with any button, its color is changed and, when the pressing thereof is desired, the remote controller is pushed forward, its color changes further and the character appears on a writing field or a desired function is executed.

1. A remote control system, comprising a hand-operated remote control device and a control menu and a motion, position or push-button operated user interface present in a display unit, the display unit's control menu included in said user interface being controlled by motional and/or positional handling of the remote control device, wherein picking up the remote control device by hand activates said user interface in the display unit.

2. A control system as set forth in claim 1, wherein the remote control device is provided with an identification feature for its pick-up by hand, which activates the remote control device and the control menu.

3. A control system as set forth in claim 1, wherein analog tuning in the user interface is executed by a rotational motion of the remote control device.

4. A control system as set forth in claim 1, wherein activation is executed by a pushing motion of the remote control device.

5. A control system as set forth in claim 1, wherein a position of the remote control device activates directly a desired menu and/or an appliance associated therewith.

6. A control system as set forth in claim 1, wherein selection buttons are on the screen of a display unit.

7. A control system as set forth in claim 1, wherein the remote control device enables the input of information through the intermediary of a keyboard present on the screen.

8. A control system as set forth in claim 1, wherein the remote control device is provided with a capacitive detector for identifying its pick- up by hand.
